(19) United States
(12) Patent Application Publication
(10) Pub. No.: US 2025/0287262 A1
(43) Pub. Date: Sep. 11, 2025

(54) SESSION CONTROL DEVICE, SIGNALING CONTROL METHOD PERFORMED BY SAME DEVICE, DATA TRANSMISSION DEVICE, AND DATA PROCESSING METHOD PERFORMED BY SAME DEVICE

(71) Applicant: SK TELECOM CO., LTD., Seoul (KR)

(72) Inventors: Seong Jun LEE, Seoul (KR); Dong Jin LEE, Seoul (KR); Hyun Jun CHOI, Seoul (KR)

(21) Appl. No.: 18/687,925

(22) PCT Filed: Aug. 19, 2022
(86) PCT No.: PCT/KR2022/012438

§ 371 Date: Aug. 28, 2024

(30) Foreign Application Priority Data
Sep. 7, 2021 (KR) 10-2021-0118933
Sep. 7, 2021 (KR) 10-2021-0135088

(51) Int. Cl. H04W 28/10; H04L 67/14; H04W 72/23

(52) U.S. Cl. CPC H04W 28/10; H04L 67/14; H04W 72/23

(57) ABSTRACT

The present invention proposes a method capable of minimizing data transmission latency by implementing a specific technical feature of avoiding additional latency of data transmission due to an additionally performed network triggered service request procedure in a situation where signaling processing is delayed compared to a data transmission rate.

### TECHNICAL FIELD

The present disclosure relates to a technology capable of minimizing data transmission delay in a situation (for example, cloud/edge, public/private, etc.) in which signal processing is slower than the data transmission rate.

The present application is based on and claims priority under 35 U.S.C. 119 to Korean Patent Application No. 10-2021-0118933, filed on Sep. 7, 2021, and Korean Patent Application No. 10-2021-0135088, filed on Sep. 7, 2021, in the Korean Intellectual Property Office, the disclosure of which is herein incorporated by reference in its entirety.

### BACKGROUND ART

In 5G, control nodes of control planes may be defined as access and mobility management functions (AMF) which control wireless section accesses of UEs, session management functions (SMF) which manage/control sessions for using data services with regard to respective UEs, network exposure functions (NEF) which share information with external networks, network repository functions (NRF) which manage/control information regarding respective nodes in networks, or the like.

In addition, data nodes of user planes in 5G may be defined as user plane functions (UPF) which transmit/receive data between UE and application server through sessions with UEs on the basis of control (interworking) of SMFs.

In 5G, control nodes of control planes and data nodes of user planes may be referred to as network functions (NFs) as a whole.

Accordingly, for data transmission by UE in 5G, paths of control planes (hereinafter, referred to as CPs) and paths of user planes (hereinafter, referred to as UPs) need to be generated regarding data transmission sessions through signaling between various NFs with respective functions defined separately.

Meanwhile, a UE in a state in which no data has been transmitted after location registration (for example, ECM-idle/CM-idle/UP deactivate) may attempt to use a data service (a UE-triggered service request).

In conventions and standards, when a UE-triggered service request occurs, a CP path (re)generation procedure is initiated in response to the UE's attempt, and when CP path generation is completed, UP path (re)generation is initiated and completed as a result of CP path generation.

However, the UE cannot be aware of the timepoint at which generation of the CP path and UP path is completed.

For this reason, the UE transmits uplink data at a self-determined timepoint for fast data transmission, and the UPF that receives uplink data (packets) may transfer the uplink data to a data node (DN) (for example, app/web/MEC service server) through a UL path which has existed before the idle state of the UE.

In addition, in the case of a general app/web/mobile edge computing (MEC) service, a (TCP/UDP etc.) handshake process is performed to establish bidirectional connection, and downlink data (packets) resulting from uplink data (packets) of the UE may be quickly transferred from the DN to the UPF.

Meanwhile, signaling between various NFs is complicatedly interlinked until (re)generation of a CP path and a UP path regarding a UE session is completed.

Therefore, there may occur a situation in which downlink data is transferred/introduced to the UPF in the course of signaling of the CP path (re)generation procedure (hereinafter, referred to as a situation in which signaling processing is slower than the data transmission rate) by the downlink data resulting from the UE's uplink data being quickly transferred to the UPF as described above.

Such a “situation in which signaling processing is slower than the data transmission rate” is highly likely to occur in a cloud/edge environment or a public/private environment.

In such a “situation in which signaling processing is slower than the data transmission rate” in which UE-related downlink data is transferred/introduced to the UPF in the course of signaling of the CP path (re)generation procedure, the UPF induces a network-triggered service request procedure with respect to the CP to transmit downlink data.

According to conventions and standards, in such a “situation in which signaling processing is slower than the data transmission rate”, data can be transmitted to the UE only after signaling of the CP path (re)generation procedure in progress and signaling of the induced/additionally performed network-triggered service request procedure are both processed successively, thereby having a problem in that additional data transmission delay occurs.

Therefore, the present disclosure may propose a scheme for avoiding additional data transmission delay due to the network-triggered service request procedure in a “situation in which signaling processing is slower than the data transmission rate”, thereby minimizing data transmission delay.

### DISCLOSURE OF INVENTION

### Technical Problem

A technical problem to be solved by the present disclosure is to implement a scheme capable of minimizing data transmission delay in a situation in which signaling processing is slower than the data transmission rate.

### Solution to Problem

A session control device according to an embodiment of the present disclosure includes: an identification unit configured to identify a specific UE which may have downlink data occurring prior to completion of control plane (CP) path generation; and a control unit configured to generate specific information, with regard to the specific UE, so as to avoid additional performing of specific signaling performed between a user plane (UP) and the CP for downlink data transmission, and configure the specific information for a network function (NF) of the UP.

Specifically, the identification unit may identify a UE which receives a UE-triggered session query as the specific UE.

Specifically, the control unit may generate the specific information according to a result of determining a session state of the specific UE at a timepoint at which the specific UE is identified, and configure the specific information for the NF of the UP.

Specifically, the control unit may, in case that base station information is identical to previous base station information as a result of determining the session state, generate UP path information based on the previous base station information as the specific information, and in case that downlink data is received prior to completion of the CP path generation in the NF of the UP, allow the downlink data to be transmitted through the UP path according to configuration of the specific information.

Specifically, the control unit may, in case that base station information is different from previous base station information as a result of determining the session state, generate delay information for delaying report which induces performing of the specific signaling as the specific information, and in case that downlink data is received prior to completion of the CP path generation in the NF of the UP, buffer the downlink data without the reporting according to configuration of the specific information and then allow the downlink data to be transmitted through a UP path according to completion of the CP path generation.

Specifically, the specific signaling may be signaling according to a network-triggered service request procedure regarding the UE in a state in which no data has been transmitted after location registration (for example, ECM-idle/CM-Idle/UP deactivate).

A signaling control method performed in a session control device according to an embodiment of the present disclosure includes: an identification operation of identifying a specific UE which may have downlink data occurring prior to completion of control plane (CP) path generation; and a control operation of generating specific information, with regard to the specific UE, so as to avoid additional performing of specific signaling performed between a user plane (UP) and the CP for downlink data transmission, and configuring the specific information for a network function (NF) of the UP.

Specifically, in the identification operation, a UE which receives a UE-triggered session query may be identified as the specific UE.

Specifically, in the control operation, the specific information may be generated according to a result of determining a session state of the specific UE at a timepoint at which the specific UE is identified, and may be configured for the NF of the UP.

Specifically, in the control operation, in case that base station information is identical to previous base station information as a result of determining the session state, UP path information based on the previous base station information may be generated as the specific information, and in case that downlink data is received prior to completion of the CP path generation in the NF of the UP, the downlink data may be allowed to be transmitted through the UP path according to configuration of the specific information.

Specifically, in the control operation, in case that base station information is different from previous base station information as a result of determining the session state, delay information may be generated as the specific information so as to delay report which induces performing of the specific signaling, and in case that downlink data is received prior to completion of the CP path generation in the NF of the UP, the downlink data may be buffered without the reporting according to configuration of the specific information and then allowed the downlink data to be transmitted through a UP path according to completion of the CP path generation.

A data transmission device according to an embodiment of the present disclosure includes: an identification unit configured to identify reception of downlink data occurring prior to completion of control plane (CP) path generation regarding a UE; and a control unit configured, in case that specific information is preconfigured with regard to the UE so as to avoid additional performing of specific signaling performed between a user plane (UP) and the CP for downlink data transmission, process the downlink data according to configuration of the specific information.

Specifically, the specific information may be configured at a timepoint at which the UE generating a UE-triggered session query is identified by a network function (NF) of the CP.

Specifically, the specific information may include information for transmitting the downlink data through UP path information based on previous base station information, or information for buffering the downlink data and then transmitting the downlink data through UP path according to completion of the CP path generation, without reporting which induces performing of the specific signaling.

Specifically, the specific signaling may be signaling according to a network-triggered service request procedure regarding the UE in a state in which no data has been transmitted after location registration (for example, ECM-idle/CM-Idle/UP deactivate).

A data processing method performed in a data transmission device according to an embodiment of the present disclosure includes: an identification operation of identifying reception of downlink data occurring prior to completion of control plane (CP) path generation regarding a UE; and a control operation of, in case that specific information is preconfigured with regard to the UE so as to avoid additional performing of specific signaling performed between a user plane (UP) and the CP for downlink data transmission, processing the downlink data deemed to be received according to configuration of the specific information.

Specifically, the specific information may include information for transmitting the downlink data through UP path information based on previous base station information, or information for buffering the downlink data and then transmitting the downlink data through UP path according to completion of the CP path generation, without reporting which induces performing of the specific signaling.

### Advantageous Effects of Invention

Embodiments of the present disclosure implement technical details for avoiding additional data transmission delay due to an additionally performed network-triggered service request procedure in a situation in which signaling processing is slower than the data transmission rate.

Therefore, the present disclosure is advantageous in that data transmission delay can be minimized in a situation in which signaling processing is slower than the data transmission rate.

### BRIEF DESCRIPTION OF DRAWINGS

FIG. 1 illustrate a problematic situation occurring in the prior art.

FIG. 2 is a block diagram illustrating the configuration of a session control device according to an embodiment of the present disclosure.

FIG. 3 is a block diagram illustrating the configuration of a data transmission device according to an embodiment of the present disclosure.

FIG. 4 and FIG. 5 are flowcharts illustrating call flows of embodiments operated by the present disclosure.

FIG. 6 is a flowchart by which a signaling control method according to an embodiment of the present disclosure is performed.

FIG. 7 is a flowchart by which a data processing method according to an embodiment of the present disclosure is performed.

### BEST MODE FOR CARRYING OUT THE INVENTION

Hereinafter, various embodiments of the present disclosure will be described with reference to the accompanying drawings.

The present disclosure relates to a technology capable of minimizing data transmission delay in a situation in which signal processing is slower than the data transmission rate.

5G communication systems define network structures for end-to-end support for UEs, base stations (access), cores, and servers, and separate control signaling and data transmission/reception functions which have been performed by a single node (for example, S-GW, P-GW, etc.) in a complex manner in existing LTE (4G), thereby defining network structures in which the control plane of the control signaling function and the user plane of the data transmission/reception function are separated.

In 5G, control nodes of control planes may be defined as access and mobility management functions (AMF) which control wireless section accesses of UEs, session management functions (SMF) which manage/control sessions for using data services with regard to respective UEs, network exposure functions (NEF) which share information with external networks, network repository functions (NRF) which manage/control information regarding respective nodes in networks, or the like.

In addition, data nodes of user planes in 5G may be defined as user plane functions which transmit/receive data between UEs and application servers through sessions with UEs on the basis of control (interworking) of SMFs.

In addition, in 5G, control nodes of control planes and data nodes of user planes may be referred to as network functions (NFs) as a whole.

Accordingly, for data transmission by UEs in 5G, paths of control planes (hereinafter, referred to as CPs) and paths of user planes (hereinafter, referred to as UPs) regarding data transmission sessions need to be generated through signaling between various NFs of respective functions defined separately.

Meanwhile, if a UE in a state in which no data has been transmitted after location registration (for example, ECM-idle/CM-idle/UP deactivate) attempts to use a data service, a UE-triggered service request may occur.

If a UE-triggered service request occurs, according to conventions and standards, a CP path (re)generation procedure is initiated in response to the UE's attempt, and if CP path generation is completed, UP path (re)generation is completed as a result of CP path generation.

However, the UE cannot be aware of the timepoint at which generation of the CP path and UP path is completed.

For this reason, the UE transmits uplink data at a self-determined timepoint for fast data transmission, and the UPF that receives uplink data (packets) may transfer the same to a data node (DN) (for example, app/web/MEC service server) through a UL path which has existed before the idle state of the UE.

In addition, in the case of a general app/web/mobile edge computing (MEC) service, a (TCP/UDP etc.) handshake process is performed to establish bidirectional connection, and downlink data (packets) resulting from uplink data (packets) of the UE may be quickly transferred from the DN to the UPF.

Meanwhile, signaling between various NFs is complicatedly interlinked until (re)generation of a CP path and a UP path regarding a UE session is completed.

Therefore, there may occur a situation in which downlink data resulting from the UE's uplink data is quickly transferred to the UPF, as described above, and is transferred/introduced to the UPF in the course of signaling of the CP path (re)generation procedure (hereinafter, referred to as a situation in which signaling processing is slower than the data transmission rate).

Such a “situation in which signaling processing is slower than the data transmission rate” is highly likely to occur in a cloud/edge environment or a public/private environment.

In such a “situation in which signaling processing is slower than the data transmission rate” in which UE-related downlink data is transferred/introduced to the UPF in the course of signaling of the CP path (re)generation procedure, the UPF induces a network-triggered service request procedure to transmit downlink data.

The network-triggered service request procedure is a conventional DDN/paging procedure.

The network-triggered service request procedure is used such that, if downlink data (packets) regarding a UE in a state in which no data has been transmitted after location registration (for example, ECM-idle/CM-idle/UP deactivate) is introduced from the outside/server, the UE is activated to reach an active (for example, ECM-active/CM-active/UP activate) state in which data transmission/reception is possible.

According to conventions and standards, in such a “situation in which signaling processing is slower than the data transmission rate”, data can be transmitted to the UE only after signaling of the CP path (re)generation procedure in progress and signaling of the induced/additionally performed network-triggered service request procedure are both processed successively, thereby having a problem in that additional data transmission delay occurs.

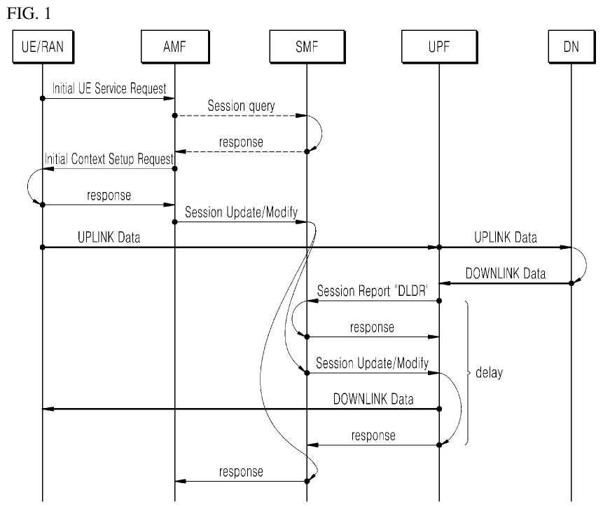

FIG. 1 illustrate a problematic situation in which additional data transmission delay occurs due to a network-triggered service request procedure in a “situation in which signaling processing is slower than the data transmission rate” as described above.

As illustrated in FIG. 1, if a UE attempts to use a data service (UE-triggered service request), a CP path (re)generation procedure regarding a data transmission session is initiated through signaling between multiple NFs (for example, AMF, SMF, UPF, etc.).

In addition, if CP path generation is completed, UP path (re)generation may be completed as a result of CP path generation.

However, the UE cannot be aware of the timepoint at which generation of the CP path and UP path is completed.

For this reason, the UE transmits uplink data at a self-determined timepoint, and the UPF that receives uplink data (packets) may transfer the same to a data node (DN) (for example, app/web/MEC service server) through a UL path which has existed before the idle state of the UE, thereby quickly transferring downlink data (packets) resulting from uplink data (packets) of the UE from the DN to the UPF.

As such, if downlink data regarding a UE is transferred/introduced to the UPF in the course of signaling of the CP path (re)generation procedure in a “situation in which signaling processing is slower than the data transmission rate”, the UPF transfers signaling that induces a network-triggered service request procedure for downlink data transmission, that is, downlink data report (DLDR) to a CP (for example, SMF).

In such a case, signaling of the CP path (re)generation procedure in progress and signaling of the network-triggered service request procedure that is additionally performed due to the session report “DLDR” collide, and downlink data transmission to the UE is possible only after all signaling of the colliding procedures is successively processed.

That is, there is a problem in that, in connection with data transmission to the UE, signaling collision occurs due to the induced/additionally performed procedure, and additional delay occurs in proportion to the resulting additional signaling.

Accordingly, the present disclosure may propose a scheme capable of minimizing data transmission delay by avoiding additional data transmission delay due to the additionally performed network-triggered service request procedure in a “situation in which signaling processing is slower than the data transmission rate”.

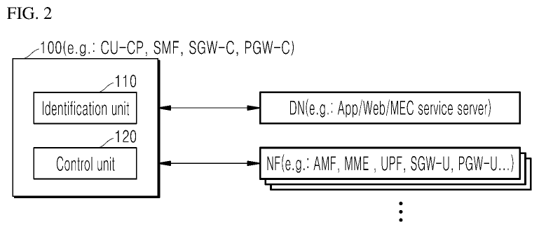

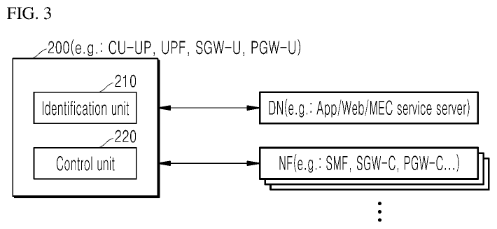

Hereinafter, technical details for implementing the technology proposed in the present disclosure (hereinafter, referred to as signaling control and data processing schemes) will be described with reference to FIG. 2 and FIG. 3.

Specifically, the present disclosure proposes a session control device and a data transmission device as NFs for implementing the proposed technology, that is, signaling control and data processing schemes.

FIG. 2 illustrates the configuration of a session control device, and FIG. 3 illustrates the configuration of a data transmission device.

The session control device 100 of the present disclosure will first be described in detail with reference to FIG. 2.

The session control device 100 may be an NF in charge of signaling control in the technology proposed in the present disclosure, that is, signaling control and data processing schemes.

The session control device 100 of the present disclosure may be a CU-CP, an SMF, or an S/PGW-C. However, it will be assumed in the following description that the session control device 100 is an SMF for convenience of description.

As illustrated in FIG. 2, the session control device 100 of the present disclosure includes an identification unit 110 and a control unit 120.

All or at least a part of the above-mentioned components of the session control device 100 may be implemented as a hardware module, a software module, or a combination of hardware and software modules.

As used herein, software modules may be understood as instructions executed by a processor that controls computations in the session control device 100, and such instructions may be loaded in a memory in the session control device 100.

Consequently, through the above-described components, the session control device 100 of the present disclosure implements the scheme to be proposed by the present disclosure, that is, signaling control that makes it possible to avoid additional data transmission delay due to the additionally performed network-triggered service request procedure in a situation in which signaling processing is slower than the data transmission rate.

Hereinafter, respective components of the session control device 100 for implementing this will be described in more detail.

The identification unit 110 is configured to identify a specific UE which may have downlink data occurring before control plane (CP) path generation is completed.

To describe a more specific embodiment, the identification unit 110 may confirm that, if a UE-triggered session query is received, the corresponding UE is the specific UE which may have downlink data occurring before CP path generation is completed.

As escribed above, if a UE in a state in which no data has been transmitted after location registration (for example, ECM-idle/CM-idle/UP deactivate) attempts to use a data service (a UE-triggered service request), an initial UE service request is transmitted from the UE/RAN to the AMF as a result of the UE's attempt, and a session query is accordingly transmitted from the AMF to the session control device 100 (for example, SMF).

If the session query is transmitted from the AMF to the session control device 100 (for example, SMF) in this manner, a CP path (re)generation procedure regarding a session for the UE's data transmission is initiated, and if CP path generation is completed, UP path (re)generation may be completed as a result of CP path generation.

As such, in the present disclosure, at a timepoint at which a UE-triggered session query is received first (initially) with regard to a UE that attempts to use a data service, a specific UE which may have downlink data occurring before CP path (re)generation is completed may be identified.

That is, the “specific UE” as used herein may also be referred to as a UE having a predicted “situation in which signaling processing is slower than the data transmission rate” wherein UE-related downlink data is transferred/introduced to the UPF (or CU-UP, S/PGW-U) in the course of signaling of the CP path (re)generation procedure.

The control unit 120 is in charge of a function of generating specific information such that, with regard to a specific UE deemed to be likely to generate downlink data prior to completion of CP path (re)generation, specific signaling performed between the UP and the CP for downlink data transmission is not performed additionally, and a function of configuring the generated specific information for the network function (NF) of the UP.

The NF of the UP for which specific information is configured may be a CU-UP, a UPF, or an S/PGW-U related to the current session of the specific UE. The NF may transfer uplink data transmitted at a timepoint self-determined by the specific UE to a data node (DN) (for example, app/web/MEC service server) through a UL path which has existed before the idle state of the specific UE. It will be assumed in the following description that the NF of the UP is a UPF for convenience of description.

The specific signaling refers to signaling based on a network-triggered service request procedure regarding a UE in a state in which no data has been transmitted after location registration (for example, ECM-idle/CM-idle/UP deactivate).

As a specific example, the specific signaling may be signaling based on a network-triggered service request procedure which may be induced/initiated by reporting (that is, DLDR) performed by the UPF.

That is, the control unit 120 may generate specific information such that, if a situation in which signaling processing is slower than the data transmission rate is predicted for a specific UE, signaling based on a network-triggered service request procedure is not additionally performed, and may transfer the same to the UPF related to the current session of the specific UE such that the specific information is configured for the UPF.

To describe a more specific embodiment, the control unit 120 may generate specific information according to the result of determining the session state of the specific UE, at the timepoint at which the specific UE is identified, and may configure the same for the NF of the UP (the UPF related to the current session).

To describe a first embodiment, if the result of determining the session state confirms that the base station information is the same as before, the control unit 120 may generate UP path information based on the previous base station information as specific information.

For example, at a timepoint at which a specific UE is identified, that is, upon receiving a UE-triggered session query received first (initially) with regard to a UE that attempts to use a data service, the control unit 120 may determine whether the UE's session state, that is, base station information (particularly, downlink tunnel endpoint ID (DL TEID)) is the same as before (before the immediately preceding idle state) through context analysis based on Session SMContext Request as the corresponding session query.

In the present disclosure, it is assumed that, if the base station information (DL TEID) has not changed, the UP path (UL path and DL path) for data transmission is the same.

If the result of determining the session state confirms that, if the base station information (particularly, DL TEID) is the same as before (before the immediately preceding idle state), the control unit 120 may generate UP path information based on the previous base station information (hereinafter, referred to as old DL TEID) as specific information.

Specific information generated in this manner may be defined as information used to transmit downlink data through UP path information based on previous base station information (old DL TEID).

The control unit 120 may transfer specific information generated by determining the session state of a specific UE upon receiving a UE-triggered session query to the UPF related to the current session such that the specific information is configured for the UPF.

In such a case, the UP (that is, corresponding UPF) may instantly transmit current downlink data through the UP path based on previous base station information (old DL TEID) according to the configuration of specific information preconfigured with regard to a specific UE (session), instead of conventionally transmitting a DLDR to the SMF so as to induce a network-triggered service request procedure, if downlink data of the specific UE is received prior to completion of CP path generation.

That is, according to the first embodiment of the present disclosure described above, in a situation in which signaling processing is slower than the data transmission rate, not only is additional data transmission delay due to the additionally performed network-triggered service request procedure avoided, but data transmission delay can also be minimized by transmitting downlink data much faster than the prior art.

To describe a second embodiment, if the result of determining the session state confirms that the base station information is different from the previous one, the control unit 120 may generate, as specific information, information that delays reporting which induces performing of specific signaling, that is, signaling based on a network-triggered service request procedure.

As described above, at a timepoint at which a specific UE is identified, that is, upon receiving a UE-triggered session query received first (initially) with regard to a UE that attempts to use a data service, the control unit 120 may determine whether the UE's session state, that is, base station information (particularly, DL TEID) is the same as before (before the immediately preceding idle state) through context analysis based on Session SMContext Request as the corresponding session query.

If the result of determining the session state confirms that the base station information (particularly, DL TEID) is different from the previous one (before the immediately preceding idle state), the control unit 120 may generate, as specific information, information that delays reporting (that is, DLDR) which induces performing of signaling based on a network-triggered service request procedure.

The specific information generated in this manner may be defined as information configured such that, without reporting (that is, DLDR) which induces performing of signaling based on a network-triggered service request procedure, downlink data is buffered and then transmitted through a UP path following CP path generation completion.

As a scheme for buffering downlink data without a DLDR, lazy update of the DLDR may be performed by configuring delay information (delay time) regarding the DLDR, thereby buffering downlink data without the DLDR.

The control unit 120 may transfer specific information generated by determining the session state of a specific UE upon receiving a UE-triggered session query to the UPF related to the current session such that the specific information is configured for the UPF.

In such a case, if downlink data of a specific UE is received prior to completion of CP path generation, the UP (that is, corresponding UPF) buffers the current downlink data without a DLDR according to configuration of specific information preconfigured with regard to the specific UE (session) and stands by, instead of conventionally transmitting a DLDR to the SMF so as to induce a network-triggered service request procedure.

In addition, the UP (that is, corresponding UPF) buffers the current downlink data and stands by such that, if a new UP path (particularly, DL TEID) following completion of CP path and UP path (re)generation is transferred from the SMF, the buffered downlink data can be transmitted through the new UP path (particularly, DL TEID).

That is, according to the second embodiment of the present disclosure described above, in a situation in which signaling processing is slower than the data transmission rate, additional data transmission delay due to the additionally performed network-triggered service request procedure may be avoided, thereby minimizing data transmission delay.

As described above, according to the session control device of the present disclosure, in a “situation in which signaling processing is slower than the data transmission rate” wherein UE-related downlink data is transferred/introduced to the UPF in the course of signaling of the CP path (re)generation procedure, induction/initiation of the additionally performed network-triggered service request procedure may be avoided, thereby preventing additional data transmission delay, and minimizing data transmission delay.

Particularly, the present disclosure is characterized in that, upon receiving a UE-triggered session query received first (initially) with regard to a UE, a determination and a configuration arc performed to avoid induction/initiation of the network-triggered service request procedure.

Next, a data transmission device 200 of the present disclosure will be described in detail with reference to FIG. 3.

The data transmission device 200 may be an NF in charge of data processing in the technology proposed in the present disclosure, that is, signaling control and data processing schemes.

The data transmission device 200 of the present disclosure may be at least one of a CU-UP, a UPF, and an S/PGW-U. However, it will be assumed in the following description that the data transmission device 200 is a UPF for convenience of description.

As illustrated in FIG. 3, the data transmission device 200 of the present disclosure includes an identification unit 210 and a control unit 220.

All or at least a part of the above-mentioned components of the data transmission device 200 may be implemented as a hardware module, a software module, or a combination of hardware and software modules.

As used herein, software modules may be understood as instructions executed by a processor that controls computations in the data transmission device 200, for example, and such instructions may be loaded in a memory in the data transmission device 200.

Consequently, through the above-described components, the data transmission device 200 of the present disclosure implements the scheme to be proposed by the present disclosure, that is, data processing that makes it possible to avoid additional data transmission delay due to the additionally performed network-triggered service request procedure in a situation in which signaling processing is slower than the data transmission rate.

Hereinafter, respective components of the data transmission device 200 for implementing this will be described in more detail.

The identification unit 210 is configured to identify reception of downlink data occurring prior to completion of a control plane (CP) path regarding a UE.

The data transmission device 200 (for example, UPF) of the present disclosure may corresponds to an NF of a UP configured to transfer uplink data transmitted at a timepoint self-determined by a UE to a data node (DN) (for example, app/web/MEC service server) through a UL path which has existed before the idle state of the UE, and then receive downlink data accordingly.

To describe a more specific embodiment, if uplink data is transferred with regard to a session (for example, ECM-idle/CM-idle/UP deactivate) requiring downlink UP path regeneration configuration, and if downlink data of the same session is then transferred/introduced, the identification unit 120 may identify downlink data reception occurring prior to completion of CP path (re)generation regarding the UE of the corresponding session.

To described another example, if downlink data of a specific UE (session) having specific information configured therefor and generated by the session control device 100 (for example, SMF) of the present disclosure, as described above with reference to FIG. 2, is transferred/introduced, the identification unit 120 may identify downlink data reception occurring prior to completion of CP path (re)generation regarding the UE of the corresponding session.

The control unit 220 is configured such that, if specific information is preconfigured to avoid additionally performing of specific signaling (signaling according to a network-triggered service request procedure) performed between the UP and the CP with regard to a UE (session) deemed to have received downlink data occurring prior to CP path (re)generation completion, the downlink data deemed to be received currently is processed according to specific information configuration.

The specific information may be generated by the NF of the CP, that is, the session control device 100 (for example, SMF) of the present disclosure, at a timepoint of identifying a UE in which a UE-triggered session query is generated.

Specifically, the session control device 100 (for example, SMF) of the present disclosure described above performs session state determination and specific information generation in order to avoid induction/initiation of a network-triggered service request procedure upon receiving a UE-triggered session query received first (initially) with regard to the UE.

According to the first embodiment, the specific information may include information configured such that the downlink data deemed to be received is transmitted through UP path information based on previous base station information.

As described above, upon receiving a UE-triggered session query received first (initially) with regard to a UE that attempts to use a data service in a situation in which no data has been transmitted after location registration (for example, ECM-idle/CM-idle/UP deactivate), the session control device 100 (for example, SMF) of the present disclosure determines whether the UE's session state, that is, base station information (particularly, DL TEID) is the same as before (before the immediately preceding idle state) through context analysis based on Session SMContext Request as the corresponding session query.

If the base station information (particularly, DL TEID) is the same as before (before the immediately preceding idle state), the session control device 100 (for example, SMF) of the present disclosure may generate UP path information based on the previous base station information (hereinafter, referred to as old DL TEID) as specific information and may transfer the same to the data transmission device 200 (for example, UPF) of the present disclosure to be configured accordingly.

As such, the specific information generated according to the first embodiment may be defined as information configured such that the downlink data deemed to be received is transmitted through UP path information based on previous base station information (old DL TEID).

If the above-described specific information is preconfigured with regard to a UE (session) deemed to have received downlink data occurring prior to CP path (re)generation completion, the control unit 220 may instantly transmit the downlink data deemed to be received currently through the UP path based on previous base station information (old DL TEID) according to the configuration of the specific information, instead of conventionally transmitting a DLDR to the SMF so as to induce a network-triggered service request procedure.

Meanwhile, according to the second embodiment, the specific information may include information configured such that, without reporting which induces performing of specific signaling, that is, signaling based on a network-triggered service request procedure, downlink data deemed to be received is buffered and then transmitted through a UP path following CP path generation completion.

As described above, upon receiving a UE-triggered session query received first (initially) with regard to a UE that attempts to use a data service in a state in which no data has been transmitted after location registration (for example, ECM-idle/CM-idle/UP deactivate), the session control device 100 (for example, SMF) of the present disclosure determines whether the UE's session state, that is, base station information (particularly, DL TEID) is the same as before (before the immediately preceding idle state) through context analysis based on Session SMContext Request as the corresponding session query.

If the base station information (particularly, DL TEID) is different from the previous one (before the immediately preceding idle state), the session control device 100 (for example, SMF) of the present disclosure may generate, as specific information, information that delays reporting (that is, DLDR) which induces performing of signaling based on a network-triggered service request procedure, and may transfer the same to the data transmission device 200 (for example, UPF) of the present disclosure to be configured accordingly.

The specific information generated according to the second embodiment in this manner may be defined as information configured such that, without the reporting (that is, DLDR) which induces performing of signaling based on a network-triggered service request procedure, downlink data is buffered and then transmitted through a UP path following CP path generation completion.

If the above-described specific information is preconfigured with regard to a UE (session) deemed to have received downlink data occurring prior to CP path (re)generation completion, the control unit 220 may buffer the downlink data deemed to be received currently and stand by without a DLDR according to the configuration of the specific information, instead of conventionally transmitting the DLDR to the SMF so as to induce a network-triggered service request procedure.

In addition, the control unit 220 buffers the downlink data deemed to be received currently and stands by such that, if a new UP path (particularly, DL TEID) following completion of CP path and UP path (re)generation is transferred from the SMF, the buffered downlink data can be transmitted through the new UP path (particularly, DL TEID).

As described above, according to the data transmission device of the present disclosure, in a “situation in which signaling processing is slower than the data transmission rate” wherein UE-related downlink data is transferred/introduced to the UPF in the course of signaling of the CP path (re)generation procedure, induction/initiation of the additionally performed network-triggered service request procedure may be avoided, thereby preventing additional data transmission delay, and minimizing data transmission delay.

Particularly, the present disclosure is characterized in that, upon receiving a UE-triggered session query received first (initially) with regard to a UE, configuration of specific information for avoiding induction/initiation of the network-triggered service request procedure is performed/completed.

As described above, embodiments of the present disclosure implement a new type of signaling control and data processing schemes wherein, in a situation in which signaling processing is slower than the data transmission rate, additional data transmission delay due to the additionally performed network-triggered service request procedure is avoided, thereby minimizing data transmission delay.

Therefore, the present disclosure is advantageous in that, in a situation in which signaling processing is slower than the data transmission rate, data transmission delay can be minimized.

Furthermore, the present disclosure is advantageous in that limitations caused by the speed/delay between the CP (for example, CU-CP, AMF/SMF, S/PGW-C) and the UP (for example, CU-UP, UPF, S/PGW-U) can be solved in a cloud/edge environment, public/private environment, etc. which have a high possibility that the situation in which signaling processing is slower than the data transmission rate will occur.

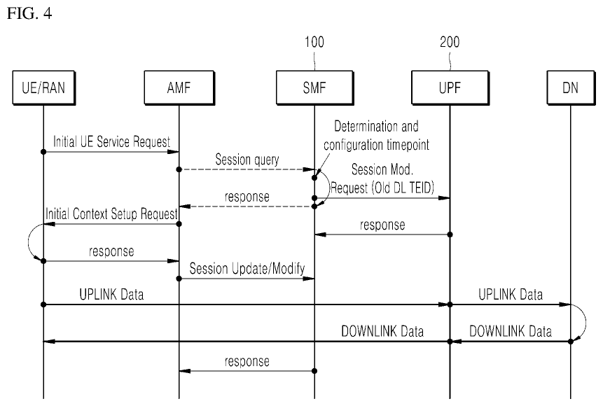

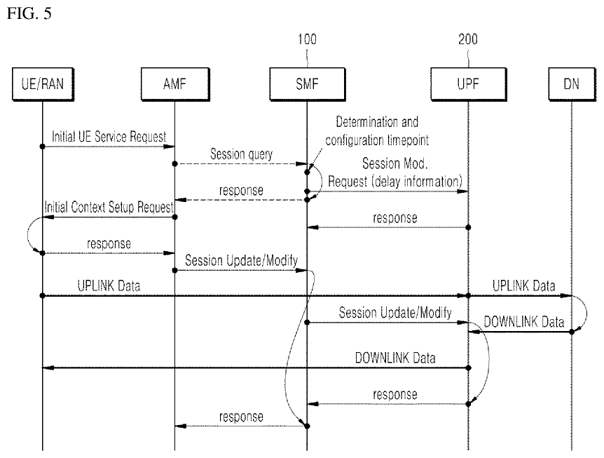

Hereinafter, embodiments in which signaling control and data processing schemes implemented by the present disclosure are operated will be described with reference to FIG. 4 and FIG. 5.

The first embodiment of the present disclosure will now be described with reference to FIG. 4.

The SMF 100 corresponding to the session control device 100 of the present disclosure initiates a CP path (re)generation procedure regarding the corresponding UE (session) upon receiving a UE-triggered session query from the AMF. If CP path generation is completed then, UP path (re)generation may be completed as a result of CP path generation.

Moreover, upon receiving a UE-triggered session query from the AMF, the SMF 100 according to the present disclosure confirms whether base station information (particularly, DL TEID) is the same as before (before the immediately preceding idle state) or different with regard to the corresponding UE (session), thereby determining whether the base station's information/position is changed.

In the present disclosure, it is assumed that, if the session state, particularly, the base station information (DL TEID) has not changed, the UP path (UL path and DL path) for data transmission is the same as before.

If the base station information (particularly, DL TEID) is the same as before (before the immediately preceding idle state) with regard to the corresponding UE (session), the SMF 100 may generate UP path information based on the previous base station information (hereinafter, referred to as old DL TEID) as specific information and may transfer the same to the UPF 200 corresponding to the data transmission device 200 of the present disclosure to be configured accordingly.

The UPF 200 may transfer uplink data transmitted at an early timepoint self-determined by the UE to a data node (DN) (for example, app/web/MEC service server) through a UL path which has existed before the idle state of the UE, and may receive downlink data in response before CP path (re)generation is completed.

According to the present disclosure, if the above-described specific information is preconfigured with regard to a UE deemed to have received downlink data occurring prior to CP path (re)generation completion, the UPF 200 according to the present disclosure may instantly transmit the downlink data deemed to be received currently through the UP path based on previous base station information (old DL TEID) according to the configuration of the specific information, instead of conventionally transmitting a DLDR to the SMF so as to induce a network-triggered service request procedure.

Consequently, according to the first embodiment of the present disclosure, the UPF 200 can not only avoid additional performing of the network-triggered service request procedure, but also transmit downlink data to the UE immediately after receiving the same.

Next, the second embodiment of the present disclosure will now be described with reference to FIG. 5.

The SMF 100 corresponding to the session control device 100 of the present disclosure initiates a CP path (re)generation procedure regarding the corresponding UE (session) upon receiving a UE-triggered session query from the AMF. If CP path generation is completed then, UP path (re)generation may be completed as a result of CP path generation.

Moreover, upon receiving a UE-triggered session query from the AMF, the SMF 100 according to the present disclosure confirms whether base station information (particularly, DL TEID) is the same as before (before the immediately preceding idle state) or different with regard to the corresponding UE (session), thereby determining whether the base station's information/position is changed.

If the base station information (particularly, DL TEID) is different from the previous one (before the immediately preceding idle state) with regard to the corresponding UE (session), the SMF 100 may generate, as specific information, information that delays the DLDR which induces performing of signaling based on a network-triggered service request procedure, and may transfer the same to the data transmission device 200 of the present disclosure to be configured accordingly.

The UPF 200 may transfer uplink data transmitted at an early timepoint self-determined by the UE to a data node (DN) (for example, app/web/MEC service server) through a UL path which has existed before the idle state of the UE, and may receive downlink data in response before CP path (re)generation is completed.

According to the present disclosure, if the above-described specific information is preconfigured with regard to a UE deemed to have received downlink data occurring prior to CP path (re)generation completion, the UPF 200 according to the present disclosure may buffer the downlink data deemed to be received currently and stand by without the DLDR according to the configuration of the specific information. If a new UP path (particularly, DL TEID) following completion of CP path and UP path (re)generation is transferred from the SMF, the buffered downlink data may be transmitted through the new UP path (particularly, DL TEID).

Consequently, according to the second embodiment of the present disclosure, the UPF 200 may avoid additional performing of the network-triggered service request procedure through DLDR delay.

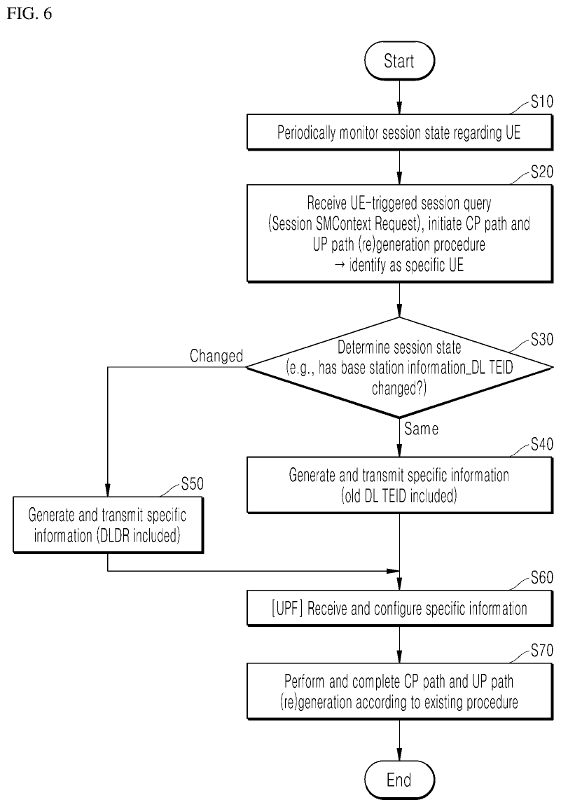

Hereinafter, a flow in which a signaling control method according to an embodiment of the present disclosure is performed will be described with reference to FIG. 6.

It will be assumed in the following description that the signaling control method according to the present disclosure is performed by the SMF 100, for convenience of description.

According to the signaling control method of the present disclosure, the SMF 100 may periodically monitor the session state regarding each UE (for example, Active—>Idle, Idle—>Active) (S10).

According to the signaling control method of the present disclosure, upon receiving a UE-triggered session query from the AMF with regard to a UE that attempts to use a data service in a state in which no data has been transmitted after location registration (for example, ECM-idle/CM-idle/UP deactivate), the SMF 100 initiates a CP path (re)generation procedure regarding the corresponding UE (session) (S20).

According to the signaling control method of the present disclosure, upon receiving a UE-triggered session query received first (initially) with regard to the UE that attempts to use a data service, the SMF 100 may confirm that the UE may have downlink data occurring prior to CP path (re)generation completion (S20).

In addition, according to the signaling control method of the present disclosure, the SMF 100 may determine whether the UE's session state, that is, base station information (particularly, DL TEID) is the same as before (before the immediately preceding idle state) through context analysis based on Session SMContext Request as the corresponding session query, with regard to the confirmed specific UE (S30).

In the present disclosure, it is assumed that, if the session state, particularly, the base station information (DL TEID) has not changed, the UP path (UL path and DL path) for data transmission is the same.

According to the signaling control method of the present disclosure, if the result of determining the session state confirms that the base station information (particularly, DL TEID) is the same as before (before the immediately preceding idle state) (“Same” in S30), the SMF 100 may generate UP path information based on the previous base station information (hereinafter, referred to as old DL TEID) as specific information and transmit the same to the UPF related to the current session (S30). The UPF may configure the transmitted specific information with regard to the corresponding session (S40).

In such a case, if downlink data of the specific UE is received prior to completion of CP path generation, the UP (that is, corresponding UPF) may instantly transmit current downlink data through the UP path based on previous base station information (old DL TEID) according to the configuration of specific information preconfigured with regard to a specific UE (session), instead of conventionally transmitting a DLDR to the SMF so as to induce a network-triggered service request procedure.

Meanwhile, according to the signaling control method of the present disclosure, if the result of determining the session state confirms that the base station information (particularly, DL TEID) is different from the previous one (before the immediately preceding idle state), the SMF 100 may generate, as specific information, information that delays the DLDR which induces performing of signaling based on a network-triggered service request procedure, and may transmit the same to the UPF related to the current session (S30). The UPF may configure the transmitted specific information with regard to the corresponding session of the UE (S40).

Moreover, the CP path (re)generation procedure disclosed in step S20 may proceed through signaling between the AMF, SMF, UPF, etc. as conventional procedures, and if CP path generation is completed, UP path (re)generation may be completed as a result of CP path generation (S70).

As described above, according to the signaling control method of the present disclosure, in a “situation in which signaling processing is slower than the data transmission rate” wherein UE-related downlink data is transferred/introduced to the UPF in the course of signaling of the CP path (re)generation procedure, induction/initiation of the additionally performed network-triggered service request procedure may be avoided.

Therefore, in the present disclosure, in a “situation in which signaling processing is slower than the data transmission rate”, additional data transmission delay due to the additionally performed network-triggered service request procedure may be prevented, and data transmission delay may also be minimized.

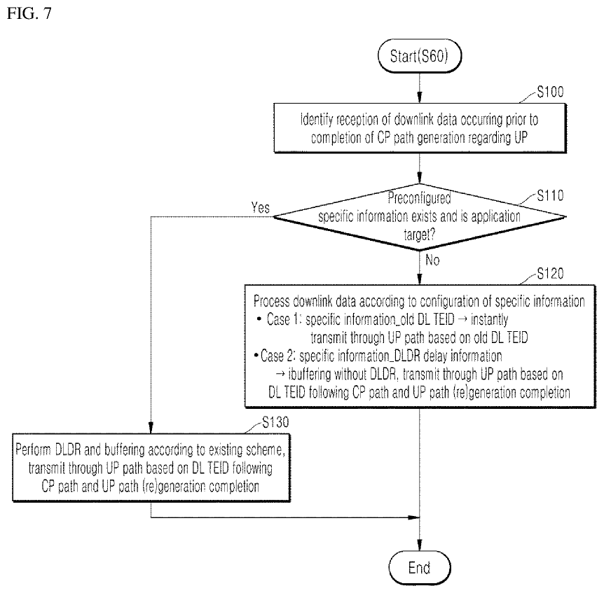

Hereinafter, a flow in which a data processing method according to an embodiment of the present disclosure is performed will be described with reference to FIG. 7.

It will be assumed in the following description that the data processing method according to the present disclosure is performed by the UPF 200, for convenience of description.

According to the data processing method of the present disclosure, the UPF 200 identifies reception of downlink data occurring prior to completion of CP path generation regarding a UE (S100).

The UPF 200 may correspond to an NF of a UP configured to transfer uplink data transmitted at a timepoint self-determined by the UE to a data node (DN) (for example, app/web/MEC service server) through a UL path which has existed before the idle state of the UE, and then receive downlink data accordingly.

To describe a specific embodiment, if uplink data is transferred with regard to a session (for example, ECM-idle/CM-idle/UP deactivate) requiring downlink UP path regeneration configuration, and if downlink data of the same session is then transferred/introduced, the UPF 200 may identify downlink data reception occurring prior to completion of CP path (re)generation regarding the UE of the corresponding session (S100).

According to the data processing method of the present disclosure, if downlink data reception is identified in step S100, the UPF 200 may determine, with regard to the UE (session) deemed to have received downlink data, whether specific information configured to avoid additional performing of signaling according to the network-triggered service request procedure exists and is an application target (S110).

According to the data processing method of the present disclosure, upon determining that specific information exists and is an application target with regard to the UE (session) deemed to have received downlink data (Yes in step S110), the UPF 200 may process the downlink data deemed to be received currently according to configuration of specific information (S120).

The specific information generated according to the first embodiment (Case 1) may be defined as information configured such that the downlink data deemed to be received is transmitted through UP path information based on previous base station information (old DL TEID).

If the specific information in Case 1 is preconfigured with regard to a UE (session) deemed to have received downlink data occurring prior to CP path (re)generation completion, the UPF 200 may instantly transmit the downlink data deemed to be received currently through the UP path based on previous base station information (old DL TEID) according to the configuration of the specific information, instead of conventionally transmitting a DLDR to the SMF so as to induce a network-triggered service request procedure (S120).

Meanwhile, the specific information generated according to the second embodiment (Case 2) may be defined as information configured such that, without the reporting (that is, DLDR) which induces performing of signaling based on a network-triggered service request procedure, downlink data is buffered and then transmitted through a UP path following CP path generation completion.

If the above-described specific information is preconfigured with regard to a UE deemed to have received downlink data occurring prior to CP path (re)generation completion, the UPF 200 may buffer the downlink data deemed to be received currently and stand by without the DLDR according to the configuration of the specific information, instead of conventionally transmitting a DLDR to the SMF so as to induce a network-triggered service request procedure. If a new UP path (particularly, DL TEID) following completion of CP path and UP path (re)generation is transferred from the SMF, the buffered downlink data may be transmitted through the new UP path (particularly, DL TEID) (S120).

As described above, according to the data transmission method of the present disclosure, in a “situation in which signaling processing is slower than the data transmission rate” wherein UE-related downlink data is transferred/introduced to the UPF in the course of signaling of the CP path (re)generation procedure, induction/initiation of the additionally performed network-triggered service request procedure may be avoided.

Therefore, in the present disclosure, in a “situation in which signaling processing is slower than the data transmission rate”, additional data transmission delay due to the additionally performed network-triggered service request procedure may be prevented, and data transmission delay may also be minimized.

A signaling control method and a data processing method according to an embodiment of the present disclosure may be implemented as program commands executable through various computer means and recorded in a computer-readable medium. The computer-readable medium may include program commands, data files, data structures, etc. alone or in combination. Program commands recorded in the medium may be those specially designed and configured for the present disclosure, or those widely known and available to those skilled in computer software. Examples of the computer-readable recording medium include magnetic media such as a hard disk, a floppy disk, and a magnetic tape, optical media such as a CD-ROM, and a DVD, magneto-optical media such as a floptical disk, and hardware devices specially configured to store and execute program commands, such as a ROM, a RAM, and a flash memory. Examples of program commands include not only machine language codes made by compilers, but also high-level languages executable by computers by using interpreters etc. The above-mentioned hardware devices may be configured to operate as one or more software modules to perform operations of the present disclosure, and vice versa.

Although the present disclosure has been described in detail with reference to exemplary embodiments, the present disclosure is not limited to the above-described embodiments, and the technical idea of the present disclosure encompasses various modifications or changes that those skilled in the art to which the present disclosure pertains could make without deviating from the gist of the present disclosure as defined in the accompanying claims.

1. A session control device comprising:
an identification unit configured to identify a specific UE where generation of downlink data is predicted prior to completion of control plane (CP) path generation; and
a control unit configured to generate specific information with regard to the specific UE, so as to avoid additional performing of specific signaling performed between a user plane (UP) and the CP for downlink data transmission, and configure the specific information for a network function (NF) of the UP.

2. The session control device of claim 1, wherein the identification unit is configured to identify a UE which receives a UE-triggered session query as the specific UE.

3. The session control device of claim 1, wherein the control unit is configured to generate the specific information according to a result of determining a session state of the specific UE at a timepoint at which the specific UE is identified, and configure the specific information for the NF of the UP.

4. The session control device of claim 3, wherein the control unit is configured to:
when base station information is identical to previous base station information as a result of determining the session state, generate UP path information based on the previous base station information as the specific information; and
when downlink data is received prior to completion of the CP path generation in the NF of the UP, allow the downlink data to be transmitted through the UP path according to configuration of the specific information.

5. The session control device of claim 3, wherein the control unit is configured to:
when base station information is different from previous base station information as a result of determining the session state, generate delay information for delaying report which induces performing of the specific signaling as the specific information; and
when downlink data is received prior to completion of the CP path generation in the NF of the UP, buffer the downlink data without the report according to configuration of the specific information and then allow the downlink data to be transmitted through a UP path according to completion of the CP path generation.

6. The session control device of claim 1, wherein the specific signaling is signaling according to a network-triggered service request procedure regarding the UE with no data transmission after location registration.

7. A signaling control method performed in a session control device, the signaling control method comprising:
identifying a specific UE where generation of downlink data is predicted prior to completion of control plane (CP) path generation; and
controlling to generate specific information, with regard to the specific UE, so as to avoid additional performing of specific signaling performed between a user plane (UP) and the CP for downlink data transmission, and configuring the specific information for a network function (NF) of the UP.

8. The signaling control method of claim 7, wherein the identifying comprises identifying a UE which receives a UE-triggered session query is identified as the specific UE.

9. The signaling control method of claim 7, wherein controlling comprises generating the specific information according to a result of determining a session state of the specific UE at a timepoint at which the specific UE is identified, and is configured for the NF of the UP.

10. A data transmission device comprising:
an identification unit configured to identify reception of downlink data occurring prior to completion of control plane (CP) path generation for a UE; and
a control unit configured, when specific information is preconfigured with regard to the UE so as to avoid additional performing of specific signaling performed between a user plane (UP) and the CP for downlink data transmission, process the downlink data according to configuration of the specific information.

11. The data transmission device of claim 10, wherein the specific information is configured at a timepoint at which the UE generating a UE-triggered session query is identified by a network function (NF) of the CP.

12. The data transmission device of claim 10, wherein the specific information comprises information for transmitting the downlink data through UP path information based on previous base station information, or information for buffering the downlink data and then transmitting the downlink data through UP path according to completion of the CP path generation, without reporting which induces performing of the specific signaling.

13. The data transmission device of claim 10, wherein the specific signaling is signaling according to a network-triggered service request procedure regarding the UE with no data transmission after location registration.

14. A data processing method performed in a data transmission device, the data processing method comprising:
identifying reception of downlink data occurring prior to completion of control plane (CP) path generation for a UE; and
controlling, when specific information is preconfigured with regard to the UE so as to avoid additional performing of specific signaling performed between a user plane (UP) and the CP for downlink data transmission, to process the downlink data according to configuration of the specific information.

15. The data processing method of claim 14, wherein the specific information comprises information for transmitting the downlink data through UP path information based on previous base station information, or information for buffering the downlink data and then transmitting the downlink data through UP path according to completion of the CP path generation, without reporting which induces performing of the specific signaling.
